(19) United States
(12) Patent Application Publication
(10) Pub. No.: US 2026/0084792 A1
(43) Pub. Date: Mar. 26, 2026

(54) ROV-OPERATED TOOL FOR DRILLING AND EXTRACTION OF SHEARED BOLTS IN SUBSEA EQUIPMENT

(71) Applicant: PETRÓLEO BRASILEIRO S.A. - PETROBRAS, Rio de Janeiro (BR)

(72) Inventors: PEDRO PAULO BEZERRA DA CUNHA CASTRO, Macaé (BR); DOUGLAS OLIVEIRA CORREA DE SOUZA, Macaé (BR); ANDRE LUIZ BEVILAQUA SANTANA, Macaé (BR)

(73) Assignee: PETRÓLEO BRASILEIRO S.A. - PETROBRAS, Rio de Janeiro, RJ (BR)

(21) Appl. No.: 19/334,181

(22) Filed: Sep. 19, 2025

(30) Foreign Application Priority Data
Sep. 26, 2024 (BR) 1020240198468

(51) Int. Cl. B63G 8/00; B25B 27/18

(52) U.S. Cl. CPC B63G 8/001; B25B 27/18; B63G 2008/005

(57) ABSTRACT

Systems and methods for drilling and extracting sheared bolts in subsea equipment. The ROV-operated tool may comprise: a subsea screwdriver comprising a fixing base, one or more hydraulic drive engines, handles for handling by ROV and a drill holder; and a reaction holder comprising a support body, a worm bolt, a reaction arm, a hydraulic engine for driving the spindle attached to the worm bolt, a fixing bracket for hydraulic hoses for driving the engines and a fixing bracket on the subsea screwdriver.

### CROSS-REFERENCE TO RELATED APPLICATIONS

This application claims the benefit of and priority to Brazilian Patent Application No. BR1020240198468, filed Sep. 26, 2024, the entire contents of which are fully incorporated herein by reference.

### BACKGROUND OF THE DISCLOSURE

### Field of the Invention

The present invention falls within the technical field of subsea operations, more specifically in the maintenance of equipment used in oil and gas production systems in underwater environments.

The invention is particularly applicable to scenarios where it is necessary to replace sheared bolts in equipment such as wet Christmas trees (WCT) (e.g., subsea tree), subsea manifolds, subsea valves, among other submerged devices, in deep or shallow water depths, where the use of divers is dangerous or impractical.

### Background

In subsea operations, especially in oil and gas exploration and production, bolts are used to join critical equipment components together. In certain cases, due to excessive forces, corrosion, or fatigue, the heads of these bolts can shear, making it impossible to remove them using conventional methods for removing bolts. This problem presents serious risks, such as the separation of joined components, leading to possible leaks, well blowouts, and other serious environmental or operational accidents.

Historically, removal of these damaged bolts relied on the intervention of divers, who would manually drill into the center of the bolt to allow the use of an extractor tool. However, this method is limited to depths of up to 300 meters and exposes divers to considerable risks. Thus, there is a need to develop a technical solution that allows drilling and removal of sheared bolts at greater depths, where the use of divers is not possible, in addition to reducing risks in shallow waters.

### Prior Art

Document CN110265161A describes a device designed to remove underwater bolt heads and form hexagonal holes in deep-water environments using electrical discharge machining (EDM). The apparatus has an approximate length of 10,825 mm and includes a main pillar, several connecting sections that can be assembled in series to form an elongated length, and an actuator device mounted at one end.

Document BR102022016967A2 refers to a specialized tool for diversless retraining of rigid hydraulic instrumentation of subsea equipment. The tool consists of a set of elements, including an ROV handle, a torque wrench, a wrench, a socket for a torque wrench and a metal structure. The metal structure is formed by “S” shaped side plates and upper and lower plates fixed by bolts, welding, or adhesive, facilitating the assembly and disassembly of components. The ROV handle is mounted perpendicular to the metal structure and can have handling arms in various shapes to optimize access and operation in subsea environments.

Document BR102022016221A2 describes a device and a method for removing cases from a production adapter base, in which the replacement device performs both the removal and enables the provision of new cases in subsea operations, being handled by means of an ROV. The device provided is a hydraulic-mechanical tool, made up of metal elements, which aims to extract a bolt that is sheared in the production adapter base chuck. Furthermore, the case replacement device comprises at least three sets of components, in the form of: lower set, intermediate set, and upper set cooperating with each other.

However, it is clear that none of the prior art documents are capable of anticipating the tool proposed by the present invention. In addition to being a smaller and lighter alternative, the present invention can be adapted to various usage scenarios, unlike what is proposed in document BR102022016221A2, for example, which is adapted for use only in production adapter base equipment of similar dimensions to those for which it was designed.

### Summary of the Invention

The present invention proposes a remotely operated vehicle (ROV)-operated tool that allows drilling of sheared bolts in subsea equipment, followed by the extraction and replacement of these bolts, both in deep and shallow waters. The tool consists of an underwater screwdriver adapted to function as a drill, a reaction holder that generates the force necessary to press the drill against the sheared bolt, and an extractor tool that facilitates the removal of the bolt after the hole has been made.

The present invention proposes a tool comprising two main components: a subsea screwdriver and a reaction holder. The subsea screwdriver is equipped with a drill holder and a reaction holder, allowing the central hole to be made in the sheared bolt. The reaction holder has a hydraulic engine that, when activated, generates a reaction force that drives the drill against the bolt, ensuring the precision and efficiency of the hole.

After drilling, the reaction holder is disassembled, and the drill holder is replaced by a bit with the extractor. The extractor, due to its reverse thread, applies torque in the direction of unbolting the sheared bolt, removing it from the structure. This process can be carried out entirely by an ROV, reducing the need for divers and allowing maintenance in deep water depths, increasing the safety and efficiency of subsea operations.

### BRIEF DESCRIPTION OF THE DRAWINGS

In order to complement the present description and provide a better understanding of the features of the present invention, and in accordance with a preferred embodiment of the present invention, a set of figures is attached herein, which represents, in an exemplary although not limiting manner, the preferred embodiment of the present invention:

FIG. 1 shows a side view of the tool, in accordance with an exemplary embodiment of the present invention.

FIG. 2 is a perspective view of the tool, in accordance with an exemplary embodiment of the present invention.

FIGS. 3A-3D are a representation of the operation steps for removing bolts with the tool, in accordance with an exemplary embodiment of the present invention.

FIGS. 4A-4B are a representation of the operation sequence required for drilling a bolt, in accordance with an exemplary embodiment of the present invention.

FIG. 5 is a representation of the extractor use to remove the bolt after it is completely drilled, in accordance with an exemplary embodiment of the present invention.

### DETAILED DESCRIPTION OF THE INVENTION

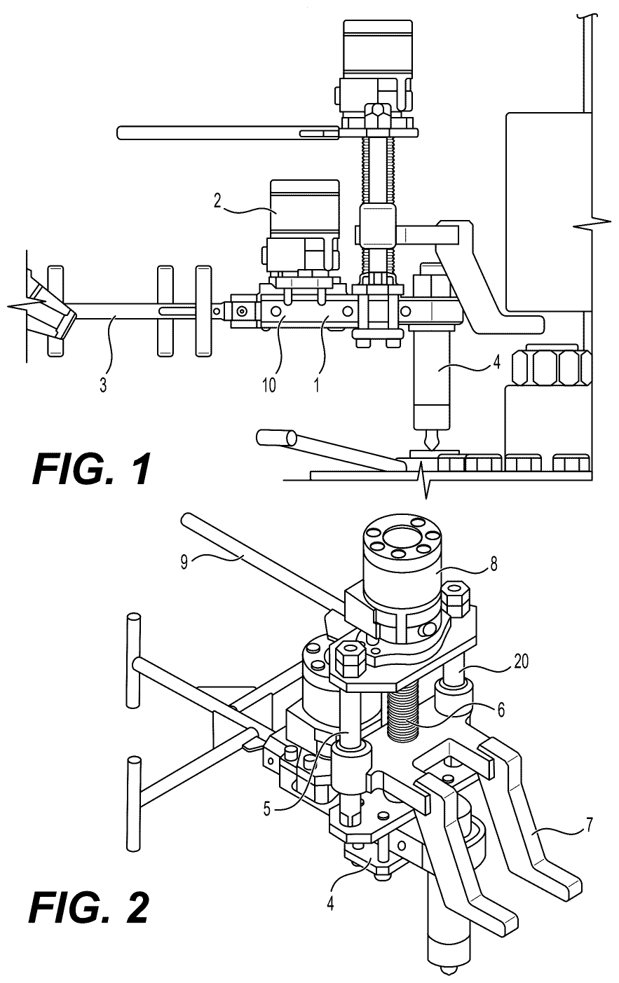

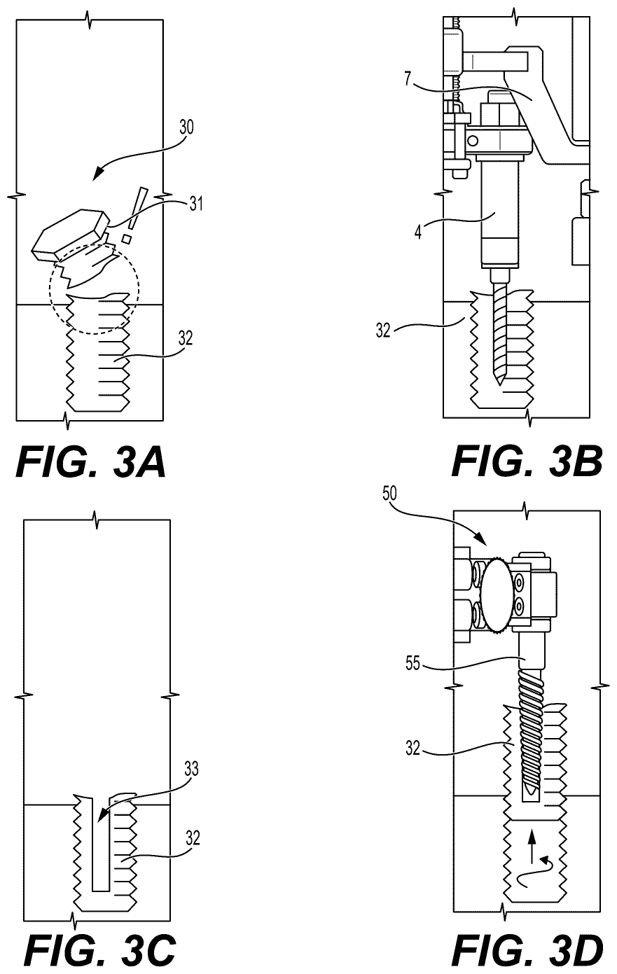

The tool may comprise two main parts, as detailed in at least FIGS. 1 and 2: subsea screwdriver 10 and reaction holder 20.

The subsea screwdriver 10 is equipped with a hydraulic engine 2 and handles 3 that allow it to be handled by a ROV. This screwdriver is adapted to operate as a drill by attaching a drill holder 4, which has a hexagonal shape at the top to fit into the screwdriver's socket.

Additionally, the subsea screwdriver 10 is configured to drill the center of the sheared bolt, creating a hole that will serve as a guide for the extractor tool.

In turn, the reaction holder 20 comprises a steel body 5 that houses a central worm bolt 6, connected to a hydraulic engine 8. The holder also includes a rod 7 for attaching the hydraulic hoses, preventing them from interfering with the ROV operation.

The worm bolt 6 is driven by the hydraulic engine of the reaction holder, causing the reaction arm 9 to move along two guide bars, until it touches a fixed structure of the subsea equipment. It generates the counterforce needed to press the drill against the sheared bolt, allowing the hole to be made.

After drilling is complete, the reaction holder can be disassembled from the screwdriver, and the drill holder is replaced with a bit containing an extractor tool 50. This extractor has a thread 55 in the opposite direction to the sheared bolt 30, allowing the extractor 50 to remove the damaged bolt 32 from the structure when applying torque.

More specifically, the ROV-operated tool for drilling and extracting shear bolts in subsea equipment of the present invention comprises: a subsea screwdriver 10 comprising: a fixing base 1, a hydraulic drive engine 2, handles for ROV handling 3, a drill holder 4, and a reaction holder 20 comprising: a support body 5, a worm bolt 6, a reaction arm 7, a hydraulic engine for driving the spindle 8 connected to the worm bolt 6, a fixing bracket for hydraulic hoses for driving the engines 9, and a fixing bracket 11 on the subsea screwdriver 10.

As mentioned, the reaction holder 20 is configured to generate a counterforce by pressing the device attached to the drill holder 4 against the sheared bolt, allowing the hole to be drilled in the bolt.

The worm bolt 6, in turn, is driven by the hydraulic engine driving the spindle 8 of the reaction holder, generating the necessary reaction force when making the reaction arm 7 touch a fixed surface of the subsea equipment.

In a preferred embodiment, the drill holder 4 of the subsea screwdriver 10 has a hexagonal shape at the top, allowing it to fit into the screwdriver socket.

Furthermore, the reaction holder 20 is removable, allowing the drill holder 4 to be replaced by a tip containing an extractor tool 50, which uses the hole 33 made in the sheared bolt 32 for its extraction. Furthermore, the reaction holder 20 is guided by two rods that make up the support body 5, ensuring the precision of the vertical movement of the reaction arm 7 along the worm bolt 6 during the drilling operation.

In this sense, the extractor 50 has a thread 55 in the opposite direction to that of the sheared bolt, allowing the bolt to be removed from the structure of the subsea equipment when torque is applied to the extractor.

It is also worth noting that, preferably, the hydraulic hoses of the screwdriver engines and the reaction holder are fixed to the fixing bracket for hydraulic hoses that drive the engines 9, so as not to interfere with the handling of the tool by the ROV.

### Tool Operation

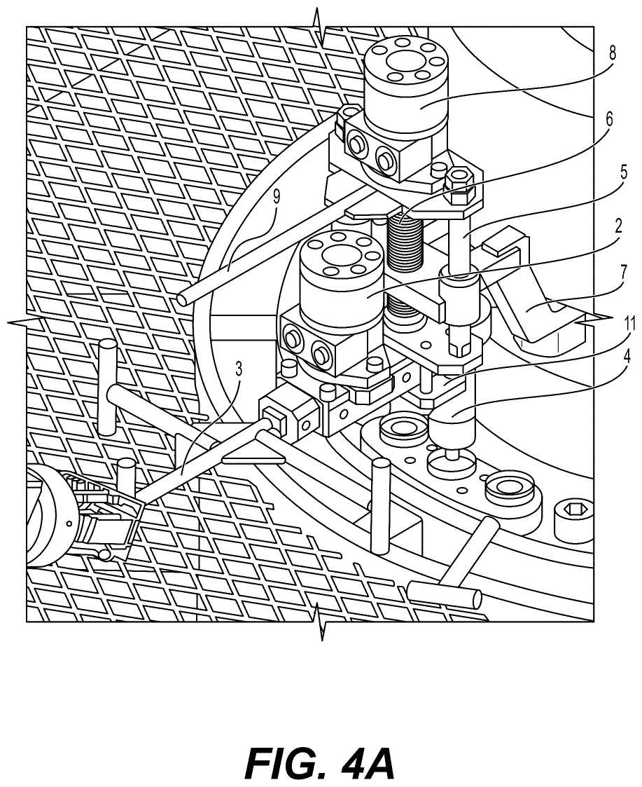

The tool operation goes through the following steps, as illustrated in FIG. 3A bolt head breakage 31; FIG. 3B bolt drilling; FIG. 3C bolt with hole 33 drilled; and FIG. 3D use of the extraction tool 50.

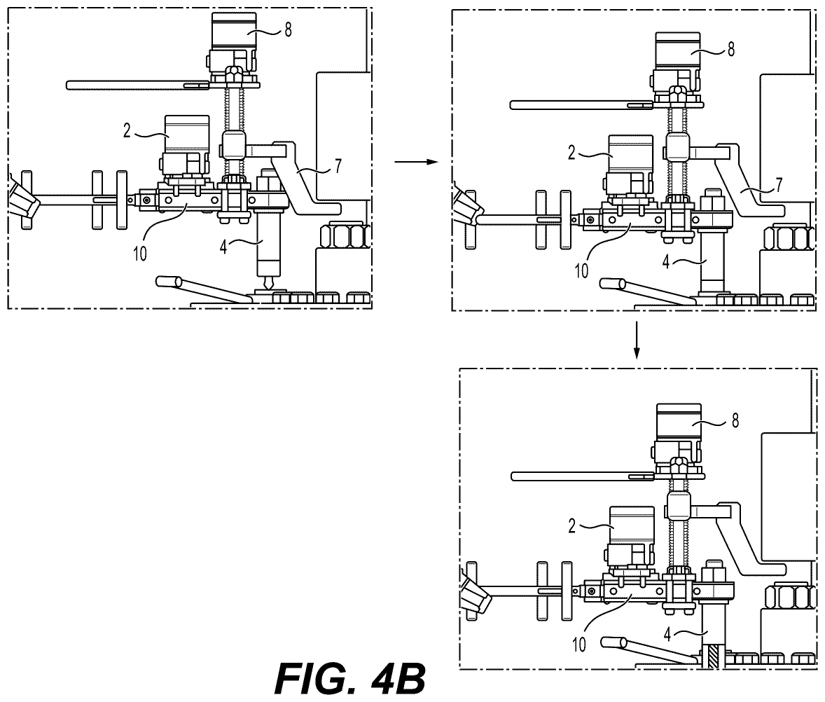

The process shown in FIG. 3B can be seen in more detail in FIGS. 4A-4B, upon rupture of the bolt head (depicted in FIG. 3A), drilling of the bolt involves the positioning, by the ROV, of the adapted screwdriver with the reaction holder at the location of the sheared bolt.

Both hydraulic engines, the one on the screwdriver and the one on the reaction stand, are activated simultaneously. The drill begins to rotate, while the reaction arm moves until it touches a fixed surface, generating the reaction force needed to drill the bolt.

Once the hole has been drilled (depicted in FIG. 3C), the reaction holder is disassembled, and the drill is replaced with the extractor tool.

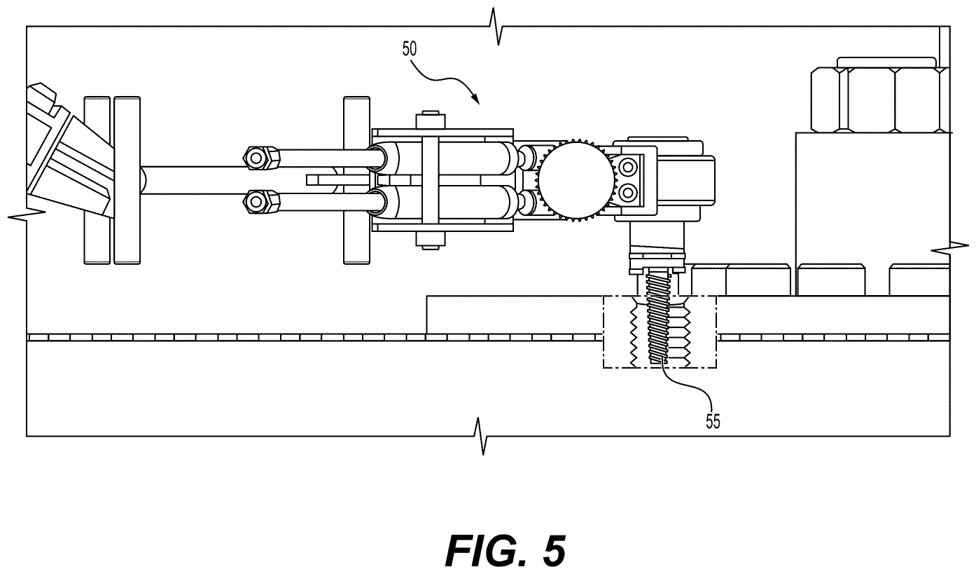

The extractor 50 is then inserted into the drilled hole 33 (depicted in FIG. 3D), as shown in FIG. 5, and by applying torque in the reverse direction, the sheared bolt 32 is removed.

After removing the damaged bolt, a new bolt can be installed using the screwdriver in the conventional way.

Thus, the tool of the present invention offers several technical and operational advantages, such as: capacity to operate at great depths; reduction of safety risks, as the tool replaces the need for human intervention, reducing exposure to risks; and operational efficiency, as it provides an efficient solution for the maintenance of underwater equipment, minimizing downtime and its costs. Therefore, in addition to the gain in personal safety, the invention can prevent serious risks to the environment, such as leaks and blowouts in equipment such as, for example: Wet Christmas Trees (WCT); Subsea Manifolds; Submerged Subsea Centrifugal Pump (SSCP) modules; subsea valves, in general, such as the Emergency Shut-Down Valve (ESDV); Riser Support Buoys (RSB); among others.

What is claimed is:

1. A remotely operated vehicle (ROV)-operated tool for drilling and extracting one or more sheared bolts, comprising:
a subsea screwdriver comprising:
a fixing base;
one or more hydraulic drive engines;
ROV handling handles;
a drill holder, and
a reaction holder comprising:
a support body;
a worm bolt;
a reaction arm;
a hydraulic engine for driving a spindle connected to the worm bolt;
a fixing bracket for hydraulic hoses for driving the engines; and
a fixing bracket on the subsea screwdriver.

2. The ROV-operated tool of claim 1, wherein the worm bolt is driven by the spindle drive hydraulic engine of the reaction holder.

3. The ROV-operated tool of claim 1, wherein the drill holder of the subsea screwdriver has a hexagonal shape at a top.

4. The ROV-operated tool of claim 1, wherein the reaction holder is removable and allows for replacing the drill holder with a tip containing an extractor.

5. The ROV-operated tool of claim 4, wherein the extractor has a thread in the opposite direction to the one or more sheared bolts.

6. The ROV-operated tool of claim 1, wherein the reaction holder is guided by two rods that make up the support body.

7. The ROV-operated tool of claim 1, wherein the reaction arm moves along the worm bolt during a drilling operation.

8. The ROV-operated tool of claim 1, wherein the hydraulic hoses of the one or more hydraulic drive engines of the subsea screwdriver and the reaction holder are fixed to the fixing bracket for hydraulic hoses for driving the engines.
